(19) United States
(12) Patent Application Publication
(10) Pub. No.: US 2016/0203501 A1
(43) Pub. Date: Jul. 14, 2016

(54) SYSTEMS AND METHODS FOR MERCHANT BUSINESS INTELLIGENCE TOOLS

(71) Applicant: Capital One Financial Corporation, McLean, VA (US)

(72) Inventors: Mark C. Pydynowski, Menlo Park, CA (US); Brad J. Larson, Richmond, VA (US)

(21) Appl. No.: 14/990,419

(22) Filed: Jan. 7, 2016

Related U.S. Application Data
(60) Provisional application No. 62/100,937, filed on Jan. 8, 2015.

(51) Int. Cl. G06Q 30/02; G06F 17/21; G06T 11/20

(52) U.S. Cl. CPC G06Q 30/0204; G06T 11/206; G06F 17/212

(57) ABSTRACT

The disclosed embodiments generally relate to systems and methods for business analytics, and more particularly, to systems and methods for merchant business intelligence tools. Disclosed embodiments may include a method for providing merchant business intelligence. In the method, a computing system, comprising one or more hardware processors, may aggregate data relating to one or more merchants, one or more customers, and transactions involving the customers or the merchants. The computing system may identify one or more categories for the customers, the merchants, and the transactions. The computing system may filter the aggregated data according to a subset of the categories of the customers, the merchants, or the transactions. The computing system may generate an analytic visualization based on analyzing the filtered aggregated data, and provide the generated analytic visualization for display.

### TECHNICAL FIELD

The disclosed embodiments generally relate to systems and methods for business analytics, and more particularly, to systems and methods for merchant business intelligence tools.

### BACKGROUND

Merchants generally determine which products to offer for sale in their stores, how to present those products to customers, and what a reasonable retail price is to sell those products. With these decisions, merchants seek to drive higher sales of profit-making retail products and/or to efficiently reduce distressed inventory. Merchants may desire to identify key demographics of consumers who are likely to purchase a product so that they may quickly attract such customers to their product displays, thereby increasing probability through a quick sale.

Currently, merchants lack information on various topics such as: where their customers spend outside of the merchants' stores, which competitors in their category or other categories are trending up or down, whether merchants are gaining or losing market share, and whether sales being up or down is unique to them or a category-wide issue. Further, merchants may not be aware of such things as: which brands are truly complementary for a partnership, which customers only shop when they receive a huge discount (and therefore are unlikely to become a regular customer), whether a new customer is truly a new customer or simply reactivated, whether their new customer is likely to become a regular customer, and whether their customer shopped them first, second, or third when the customers go shopping.

Moreover, merchants may lack an understanding of issues regarding the competition landscape, such as: which geographies to invest in or avoid, the degree to which merchants' customers cross-shop and at each competitor, where to spend their advertising budget to reach their highest value customers, whether a new or existing competitor store is stealing their market share, or whether their competitor's new data-specific promotion worked.

Thus, a need exists for systems and methods for merchant business intelligence tools that can provide answers to such questions.

### SUMMARY

In the following description, certain aspects and embodiments of the present disclosure will become evident. It should be understood that the disclosure, in its broadest sense, could be practiced without having one or more features of these aspects and embodiments. Specifically, it should also be understood that these aspects and embodiments are merely exemplary. Moreover, although disclosed embodiments are discussed in the context of merchant systems and environments for ease of discussion, it is to be understood that the disclosed embodiments are not limited to any particular industry. Instead, disclosed embodiments may be practiced by any entity in any industry that would benefit from an improved understanding of individual or collective human behavior.

Disclosed embodiments may include a merchant business intelligence system. The system may comprise one or more memory devices storing instructions, and one or more hardware processors configured to execute the instructions to perform operations. The operations may aggregate data relating to one or more merchants, one or more customers, and transactions involving the customers or the merchants. The operations may identify one or more categories for the customers, the merchants, and the transactions. The operations may filter the aggregated data according to a subset of the categories of the customers, the merchants, or the transactions. The operations may generate an analytic visualization based on analyzing the filtered aggregated data, and provide the generated analytic visualization for display.

Disclosed embodiments may include a method for providing merchant business intelligence. In the method, a computing system, comprising one or more hardware processors, may aggregate data relating to one or more merchants, one or more customers, and transactions involving the customers or the merchants. The computing system may identify one or more categories for the customers, the merchants, and the transactions. The computing system may filter the aggregated data according to a subset of the categories of the customers, the merchants, or the transactions. The computing system may generate an analytic visualization based on analyzing the filtered aggregated data, and provide the generated analytic visualization for display.

In accordance with additional embodiments of the present disclosure, a computer-readable medium is disclosed that stores instructions that, when executed by a processor(s), causes the processor(s) to perform operations consistent with one or more disclosed methods.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary environment for implementing merchant business intelligence tools, consistent with disclosed embodiments;

FIG. 2 is a block diagram of exemplary computing equipment for implementing merchant business intelligence tools, consistent with disclosed embodiments;

FIG. 3 is a block diagram of exemplary sub-systems for implementing merchant business intelligence tools, consistent with disclosed embodiments;

FIG. 4 is a diagram of exemplary data that may be collected about customers in stores, consistent with disclosed embodiments;

FIG. 5 is an exemplary data structure of aggregate consumer data that may be compiled about consumers, consistent with disclosed embodiments;

FIGS. 6A-B is a flowchart of an exemplary process for implementing merchant business intelligence tools, consistent with disclosed embodiments; and

FIGS. 7-9 depict exemplary user interfaces for a merchant business intelligence tool.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts.

Certain disclosed embodiments provide systems and methods for merchant business intelligence tools. The tools may allow merchants to answer valuable business questions about their customers and competitors. First, various types of data from multiple sources may be aggregated including, but not limited to, customer spend data, merchant data, and US Census data. The tools may analyze the aggregated data, e.g., for calculating market share shifts, customer visit frequency, share of competitive wallet of a consumer that is spent in a merchant's store, etc. The tools may provide a graphical user interface to visualize the data and generate actionable insights that answer valuable business questions for merchants such as: “where do my customers spend outside my store?,” or “which customers am I losing, and where are they going?”

For example, the disclosed merchant business intelligence tools may use transaction-level data to generate novel insights for merchants, including insights into the types of people that shop at their stores, at what other merchants those types of people shop, insights into market segments, and comparative performance versus competitors.

Disclosed tool embodiments may operate upon aggregated data relating to customers, which may be categorized and filtered by age, gender, transaction frequency, location frequency, or consumer engagement level (e.g., level of spending, number of purchased items per visit, etc.), among other demographics. Disclosed tool embodiments may further operate upon aggregated data relating to merchants, which may be categorized and filtered by merchant name, industry, industry sub-category, new or existing locations, etc. Disclosed tool embodiments may further operate upon aggregated data relating to individual transactions, which may be categorized and filtered by time of day, day of week, and purchase channel, among other transaction attributes.

In disclosed embodiments, analytical results may be presented in a number of visualizations on a webpage. Users may have the ability to filter the data shown in visualizations on-demand and see changed results rendered in real-time, allowing users to explore customers and merchant market share in an interactive, dynamic manner. Users may also be able to export the visualizations to a number of user-friendly formats. For example, when a user filters the data in a manner such as those discussed above, the filter values may passed to a back-end server, where the analytics query may be constructed and executed. The results may be streamed back to the user's device in real time. Once all results are received, the visualization may be automatically updated with any new data.

Various disclosed embodiments may provide advantages such as: (1) granularity of analysis, (2) dynamic analysis, and (3) advanced analytics.

For example, certain disclosed embodiments may allow merchants to analyze customer behavior and competitive landscape issues with granularity, for example, according to: (A) geographic levels (e.g., from by region, country, state, zip code, etc.); (B) customer segment (e.g., new, almost lapsed, lapsed, existing, reactivated, and the like); (C) time of day; (D) day of week; (E) customized customer frequency segments; and (F) customized list of competitors.

Certain disclosed embodiments may provide for dynamic analysis of customer behavior and competitive landscape. For example, certain disclosed embodiments may allow merchants to set or change filters and see displayed results updated in real-time. This real-time feature may overcome the multi-day time lag of traditional solutions where merchants typically make a request, then wait multiple days for the report to be created, receive the report, and then make modifications to the original request because the report requires changes.

Certain disclosed embodiments may provide advanced analytics, such as: (A) calculating market share shift corresponding to a specific time period with a customized competitor set; (B) conducting analysis from a panel cohort or point-in-time perspective; (C) comparing merchant performance to an average industry standard; or (D) comparing to customers' total spend shift and the category's total spend against customers of other merchants.

Various additional advantages may be obtained through the disclosed embodiments. For example, the tools of the disclosed embodiments may make recommendations automatically, based on the analytics. For example, recommendations may include opening or closing particular merchant stores, increasing or decreasing use of a particular retail channel (phone, on-line, TV, or in-store), etc. The tools may be integrated with a merchant's existing customer relationship management (CRM) system. The tools may allow merchants to message/survey specific customers based on the tools' analysis. Also, the tools may allow merchants to create custom visualizations on demand, in addition to default visualizations.

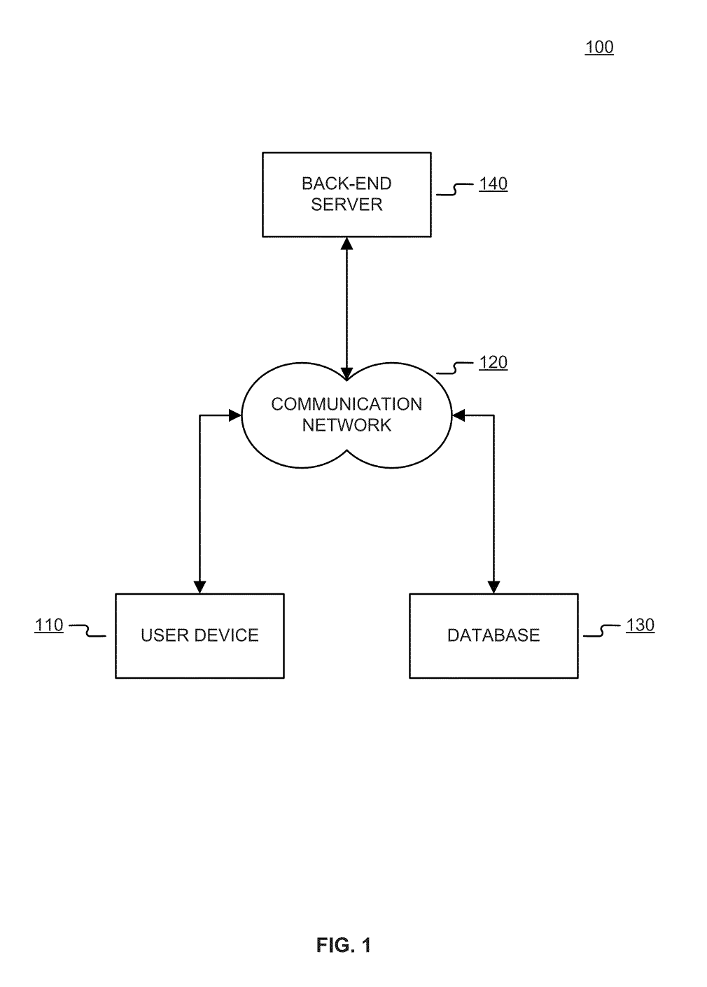

FIG. 1 is a block diagram of an exemplary environment for implementing merchant business intelligence tools, consistent with disclosed embodiments. As shown in FIG. 1, system 100 may include user devices 110, databases 130, and back-end servers 140, as well as a communication network 120 to facilitate communication among the other components of system 100. The components and arrangement of the components included in system 100 may vary. Thus, system 100 may further include other components that perform or assist in the performance of one or more processes consistent with the disclosed embodiments. The components and arrangements shown in FIG. 1 are not intended to limit the disclosed embodiments, as the components used to implement the disclosed processes and features may vary.

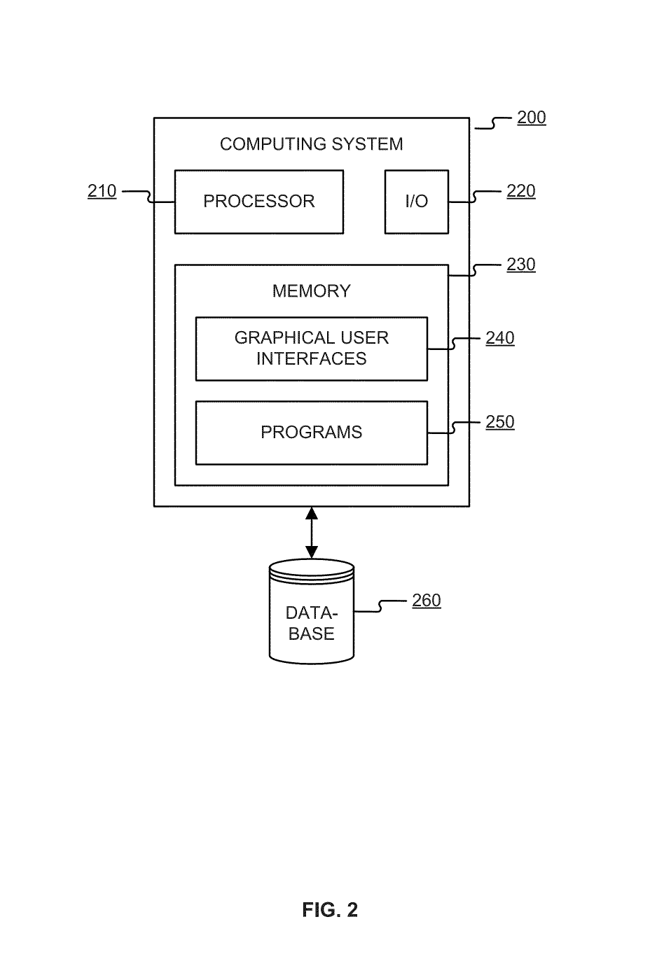

System 100 may include one or more user devices 110. A user may operate a user device 110, which may be a desktop computer, laptop, tablet, smartphone, multifunctional watch, pair of multifunctional glasses, or any other suitable computing device. User device 110 may include one or more processor(s) and memory device(s) known to those skilled in the art. For example, user device 110 may include memory device(s) that store data and software instructions that, when executed by one or more processor(s), perform operations consistent with the disclosed embodiments. In one aspect, user device 110 may have an application installed thereon, which may enable user device 110 to communicate with back-end servers 140 and/or database 130 via communication network 120. For instance, user device 110 may be a smartphone or tablet (or the like) that executes an application that logs the user device 110 into the back-end server 140. In some embodiments, user device 110 may connect to back-end servers 140 through an application programming interface configured to communicate information to the back-end servers 140, or through use of browser software stored and executed by user device 110. User device 110 may be configured to execute software instructions associated with the application to allow a user to access information stored in back-end server 140, such as, for example, device information, user profile information, user demographic categories, merchant business intelligence tools, and the like. Additionally, user device 110 may be configured to execute software instructions that initiate and interact with store equipment of a merchant (not shown) to facilitate, for example, purchase transactions or barcode scans of retail sales products. A user may operate user device 110 to perform one or more operations consistent with the disclosed embodiments. In one aspect, a user may be a customer of the store associated with back-end server 140. An exemplary computer system consistent with user device 110 is discussed in additional detail with respect to FIG. 2.

In accordance with disclosed embodiments, system 100 may include back-end servers 140. Back-end servers 140 may be a system associated with a retailer (not shown), or an information technology service provider (not shown), or a financial institution (not shown) such as a bank, a credit card company, a credit bureau, a lender, brokerage firm, or any other type of financial service entity. Back-end servers 140 may be one or more computing systems that are configured to execute software instructions stored on one or more memory devices to perform one or more operations consistent with the disclosed embodiments. For example, back-end servers 140 may include one or more memory device(s) storing data and software instructions and one or more hardware processor(s) configured to use the data and execute the software instructions to perform server-based functions and operations known to those skilled in the art. Back-end servers 140 may include one or more general-purpose computers, mainframe computers, dedicated hardware, or any combination of these types of components.

In certain embodiments, back-end servers 140 may be configured as a particular apparatus, system, and the like based on the storage, execution, and/or implementation of the software instructions that perform one or more operations consistent with the disclosed embodiments. Back-end servers 140 may be standalone, or it may be part of a subsystem, which may be part of a larger system. For example, back-end servers 140 may represent distributed servers that are remotely located and communicate over a network (e.g., communication network 120) or a dedicated network, such as a LAN, for a financial service provider. An exemplary computing system consistent with back-end servers 140 is discussed in additional detail with respect to FIG. 1, below.

Back-end servers 140 may include or may access one or more storage devices (e.g., FIG. 1, database 130, FIG. 2, memory 230 and/or database 260) configured to store data and/or software instructions used by one or more processors of back-end servers 140 to perform operations consistent with disclosed embodiments. For example, back-end servers 140 may include memory 230 configured to store one or more software programs that performs various functions when executed by a processor. The disclosed embodiments are not limited to separate programs or computers configured to perform dedicated tasks. For example, back-end servers 140 may include memory that stores a single program or multiple programs. Additionally, back-end servers 140 may execute one or more programs located remotely from back-end servers 140. For example, back-end servers 140 may access one or more remote programs stored in memory included with a remote component (not shown) that, when executed, perform operations consistent with the disclosed embodiments. In certain aspects, back-end servers 140 may include server software that generates, maintains, and provides user applications, customer data, user profile information, user demographics information, physical/electronic retail store information, and/or the like. In other aspects, back-end servers 140 may connect separate server(s) or similar computing devices that generate, maintain, and provide such services.

Other components known to one of ordinary skill in the art may be included in system 100 to process, transmit, provide, and receive information consistent with the disclosed embodiments. In addition, although not shown in FIG. 1, components of system 100 may communicate with each other through direct communications. Direct communications may use any suitable technologies, including, for example, wired technologies (e.g., Ethernet, PSTN, etc.), wireless technologies (e.g., Bluetooth™, Bluetooth LE™, Wi-Fi™, near field communications (NFC), etc.), or any other suitable communication method(s) that provide a medium for transmitting data between separate devices.

FIG. 2 is a block diagram of exemplary computing system 200 for implementing merchant business intelligence tools, consistent with disclosed embodiments. Computing system 200 may be associated with user devices 110, equipment associated with communication network 120 or database 130, and/or back-end servers 140, consistent with disclosed embodiments. In one embodiment, computing system 200 may have one or more processors 210, one or more memories 230, and one or more input/output (I/O) devices 220. In some embodiments, computing system 200 may take the form of a server, general-purpose computer, a mainframe computer, laptop, smartphone, mobile device, or any combination of these components. In certain embodiments, computing system 200 (or a system including computing system 200) may be configured as a particular apparatus, system, and the like based on the storage, execution, and/or implementation of the software instructions that perform one or more operations consistent with the disclosed embodiments. Computing system 200 may be standalone, or it may be part of a subsystem, which may be part of a larger system.

Processor 210 may include one or more known processing devices, such as a microprocessor from the Pentium™ or Xeon™ family manufactured by Intel™, the Turion™ family manufactured by AMD™, or any of various processors manufactured by Sun Microsystems. Processor 210 may constitute a single core or multiple core processor that executes parallel processes simultaneously. For example, processor 210 may be a single core processor configured with virtual processing technologies. In certain embodiments, processor 210 may use logical processors to simultaneously execute and control multiple processes. Processor 210 may implement virtual machine technologies, or other known technologies to provide the ability to execute, control, run, manipulate, store, etc. multiple software processes, applications, programs, etc. In another embodiment, processor 210 may include a multiple-core processor arrangement (e.g., dual, quad core, etc.) configured to provide parallel processing functionalities to allow computing system 200 to execute multiple processes simultaneously. One of ordinary skill in the art would understand that other types of processor arrangements could be implemented that provide for the capabilities disclosed herein. The disclosed embodiments are not limited to any type of processor(s) configured in computing system 200.

Memory 230 may include one or more storage devices configured to store instructions used by processor 210 to perform functions related to the disclosed embodiments. For example, memory 230 may be configured with one or more software instructions, such as program(s) 250 that may perform one or more operations when executed by processor 210. The disclosed embodiments are not limited to separate programs or computers configured to perform dedicated tasks. For example, memory 230 may include a program 250 that performs the functions of computing system 200, or program 250 could comprise multiple programs. Additionally, processor 210 may execute one or more programs located remotely from computing system 200. For example, user devices 110, devices within communication network 120, databases 130, and back-end servers 140, may, via computing system 200 (or variants thereof), access one or more remote programs that, when executed, perform functions related to certain disclosed embodiments. Processor 210 may further execute one or more programs located in database 260. In some embodiments, programs 250 may be stored in an external storage device, such as a cloud server located outside of computing system 200, and processor 210 may execute programs 250 remotely.

Programs executed by processor 210 may cause processor 210 to execute one or more processes related to implementing merchant business intelligence tools. Programs executed by processor 210 may further cause processor 210 to execute one or more processes related to statistical demographic analysis of customer information. Programs executed by processor 210 may also cause processor 210 to execute one or more processes related to financial services provided to users including, but not limited to, processing credit and debit card transactions, checking transactions, fund deposits and withdrawals, transferring money between financial accounts, lending loans, processing payments for credit card and loan accounts, processing ATM cash withdrawals, or the like. Programs executed by processor 210 may further cause processor 210 to execute one or more processes related to aggregating census data, consumer financial transaction data, user profile data, and merchant information.

Memory 230 may also store data reflecting any type of information in any format that the system may use to perform operations consistent with the disclosed embodiments. Memory 230 may store instructions to enable processor 210 to execute one or more applications, such as server applications, a customer data aggregation application, a customer demographic statistical analysis application, network communication processes, and any other type of application or software. Alternatively, the instructions, application programs, etc. may be stored in an external storage (not shown) in communication with computing system 200 via communication network 120 or any other suitable network. Memory 230 may be a volatile or non-volatile, magnetic, semiconductor, tape, optical, removable, non-removable, or other type of storage device or tangible (e.g., non-transitory) computer-readable medium.

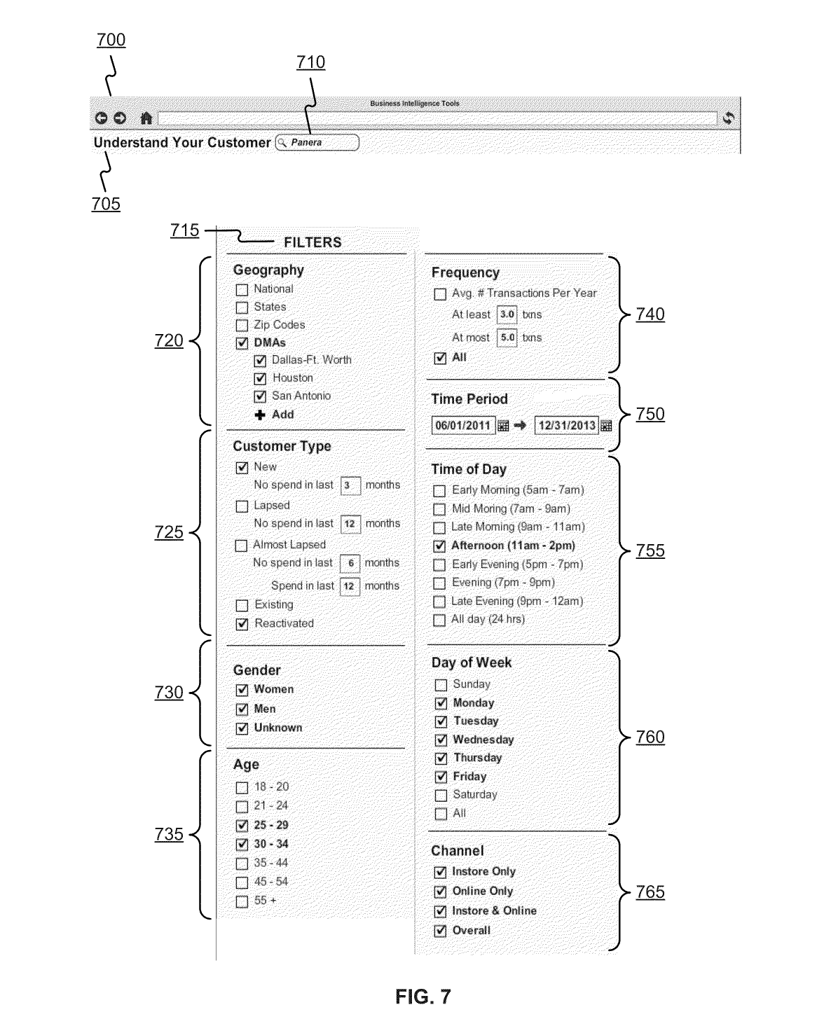

Memory 230 may include graphical user interfaces (“GUI”) 240. GUI 240 may allow a user to access, modify, etc. user profile information, user demographic information, merchant information, census information, merchant business intelligence tools, and/or the like. In certain aspects, as explained further below with reference to FIGS. 7-9, GUI 240 may facilitate an operator to view raw aggregated customer information, customer demographic information, visualizations of statistical analyses, merchant business intelligence tools, or the like. Additionally or alternatively, GUI 240 may be stored in database 260 or in an external storage (not shown) in communication with computing system 200 via networks 120 or any other suitable network.

I/O devices 220 may be one or more device that is configured to allow data to be received and/or transmitted by computing system 200. I/O devices 220 may include one or more digital and/or analog communication devices that allow computing system 200 to communicate with other machines and devices, such as other components of system 100 shown in FIG. 1. For example, computing system 200 may include interface components that provide interfaces to one or more input devices, such as one or more keyboards, mouse devices, and the like, which may enable computing system 200 to receive input from an operator of user device 110.

Computing system 200 may also comprise one or more database(s) 260. Alternatively, computing system 200 may be communicatively connected to one or more database(s) 260. Computing system 200 may be communicatively connected to database(s) 260 through network 120. Database 260 may include one or more memory devices that store information and are accessed and/or managed through computing system 200. By way of example, database(s) 260 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. Database 260 may include computing components (e.g., database management system, database server, etc.) configured to receive and process requests for data stored in memory devices of database(s) 260 and to provide data from database 260.

As discussed above, user devices 110 and/or back-end servers 140 may include at least one computing system 200. Further, although sometimes discussed here in relation to back-end server 140, it should be understood that variations of computing system 200 may be employed by other components of system 100, including user devices 110 or database 130. Computing system 200 may be a single server or may be configured as a distributed computer system including multiple servers or computers that interoperate to perform one or more of the processes and functionalities associated with the disclosed embodiments.

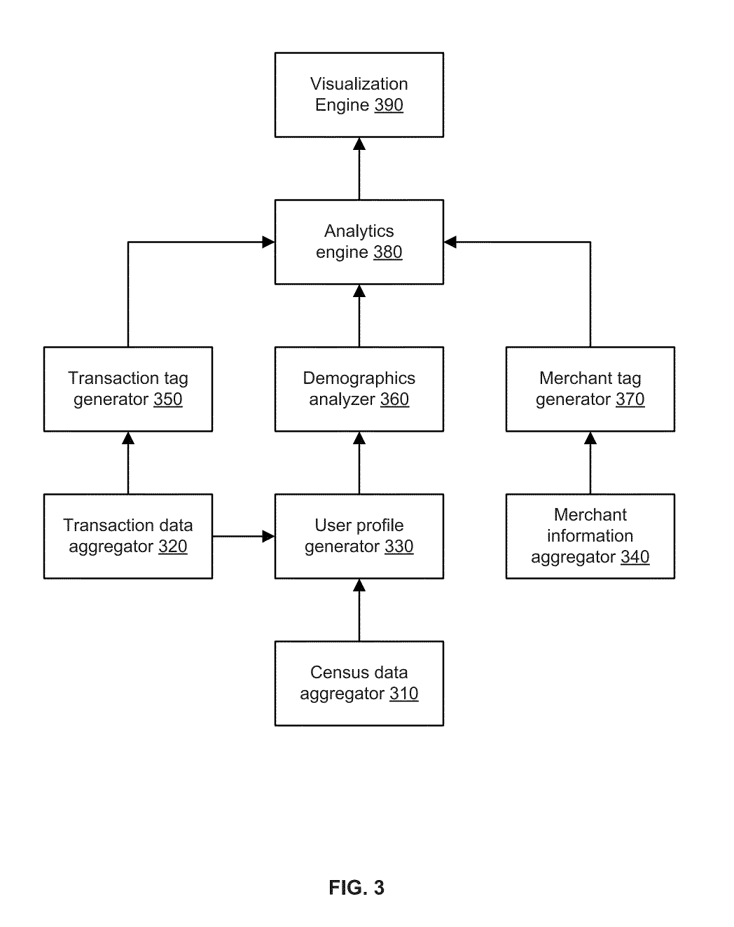

FIG. 3 is a block diagram of exemplary sub-systems for implementing merchant business intelligence tools, consistent with disclosed embodiments. In some embodiments, a database (e.g., implemented in memory 230 or database 260) may store aggregated data of various types. As examples, the database may store user application data, user profiles, customer location (e.g., geographical, in-store, etc.) data, demographic categories, etc. The database may receive such data from various sources, e.g., web crawlers, online surveys, social networks, financial transaction data, etc. Thus, in some embodiments, system 100 may include subsystems for aggregating such data. For example, system 100 may include a census data aggregator 310 to obtain data regarding a population of consumers or the broader general public. Examples of such information include, without limitation, age, gender, marital status, family size, financial account information, credit card or banking information, occupation, salary, and/or the like. Similarly, system 100 may include a transaction data aggregator 320, e.g., to collect information (e.g., purchase data, credit card information, user financial profile information such as billing and shipping address, etc.) relating to purchases made by consumers from merchants. In some embodiments, system 100 may include a user profile generator 330. User profile generator 330 may parse the aggregated data regarding consumers, and order the data into profiles for individual users or groups of users. In addition, in some embodiments, system 100 may include a merchant information aggregator 340. Merchant information aggregator 340, in like manner to the transaction data aggregator 320, may collect information about merchants, such as identification(s), trademark names, addresses, retail channels (e.g., phone, TV, online, brick-and-mortar, etc.), inventory, advertisements, etc. Inventory information may include fields such as, without limitation, store ID, stock-keeping unit (SKU) ID, SKU name, quantity, stock date, expiry date, retail price, and/or the like.

In some embodiments, system 100 may include subsystems to analyze aggregated data and categorize or tag the data with labels or metadata indicating associations to various categories. For example, a transaction tag generator 350 may analyze aggregated transaction data provided by transaction data aggregator 320, and may embed tags into the transaction data records. The tags may, for example, indicate a type of product, type of payment used for the transaction (e.g., virtual wallet, debit, credit), a geographic location, a merchant identifier, a retail channel identifier, and/or the like. A merchant tag generator 370 may analyze aggregated merchant information provided by merchant information aggregator 340, and may embed tags into the merchant information records. These tags may, for example, indicate a merchant type (small, large, sole proprietorship, etc.), merchant available retail channels, merchant geographic locations, and/or the like. A demographics analyzer 360 may analyze aggregated user profiles provided by user profile generator 330, and may embed tags into the user profile records. These tags may represent various demographic categories to which the user may belong based on, e.g., age, gender, marital status, income level, consumption amount, frequency of consumption, type of consumptions, occupation, etc. In general, it is to be understood that any of the tagging subsystems may employ any range of tags to indicate categories to which the tagged entities or data belong.

In some embodiments, an analytics engine 380 may operate on the tagged records, as well as the raw underlying aggregated information, to implement merchant business intelligence tools. Analytics engine 380 may identify trends, recognize data patterns, and draw inferences from the tags and aggregated data. Analytics engine 380 may provide such intelligence information to a visualization engine 390, which may render the information in a form ready for presentation and manipulation via a display device (e.g., user device 110) to a user.

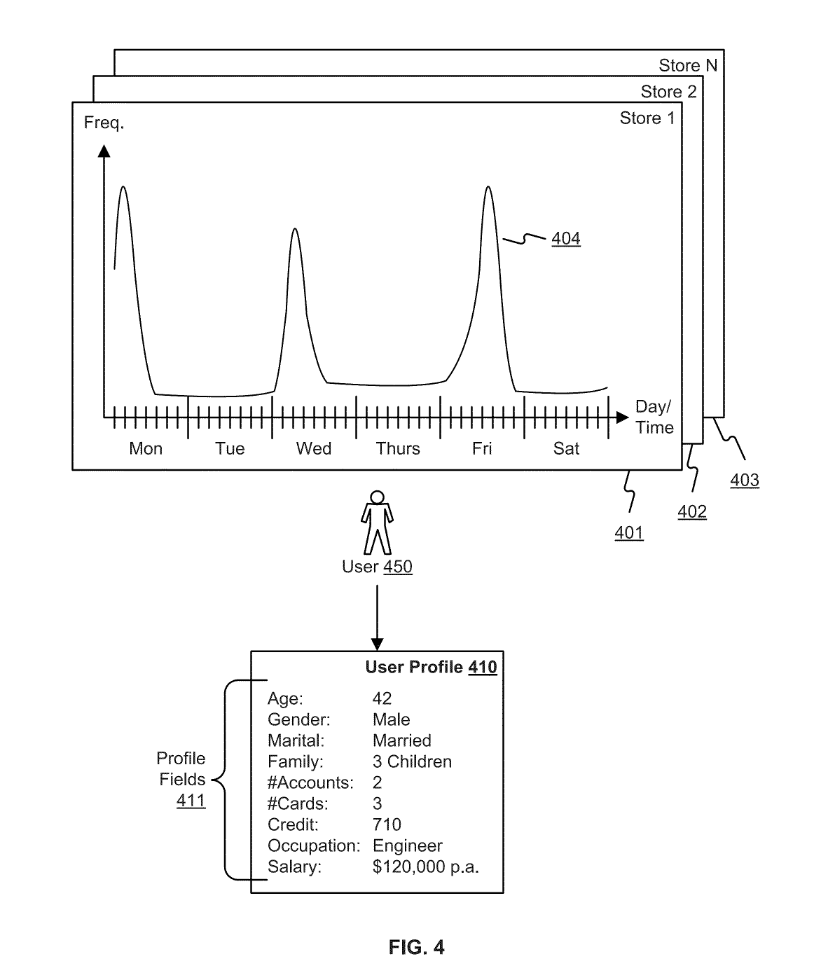

FIG. 4 is a diagram of exemplary data that may be collected about customers in stores, consistent with disclosed embodiments. In some embodiments, a back-end server may aggregate data about a user 450 in retail stores. The back-end server may aggregate transaction data (e.g., purchase data, credit/debit card information, etc.) from various stores, and may identify stores that a user frequents based on the aggregated transaction data. The back-end server may also collect information about server from various sources, e.g., through web crawlers, social networks, app data from an app executing on the user's device (e.g., apps that check in to a store when the user enters the store), online surveys, etc. Accordingly, the back-end server may be able to build a user profile 410 for the user 450, and associate the user profile information 411 with the user's profile 410. The back-end server may obtain information to populate the user profile fields 411 from an application executing on the user's device, from Internet searches using keyword information obtained from the user, by requesting the user 450 to log into a social network so that the back-end server may query the social network for user profile information, and other such methods. The user profile fields 411 may include information such as, without limitation, age, gender, marital status, family size, financial account information, credit card or banking information, occupation, salary, and/or the like. In this manner, demographics of the user 450 may be associated with user profile 410. In certain embodiments, updated association of user consumption behavior with user demographics may be conducted in real-time (e.g., as users engage in consumption behavior with merchants) for substantially all (e.g., ˜90%) users handled by the system 100.

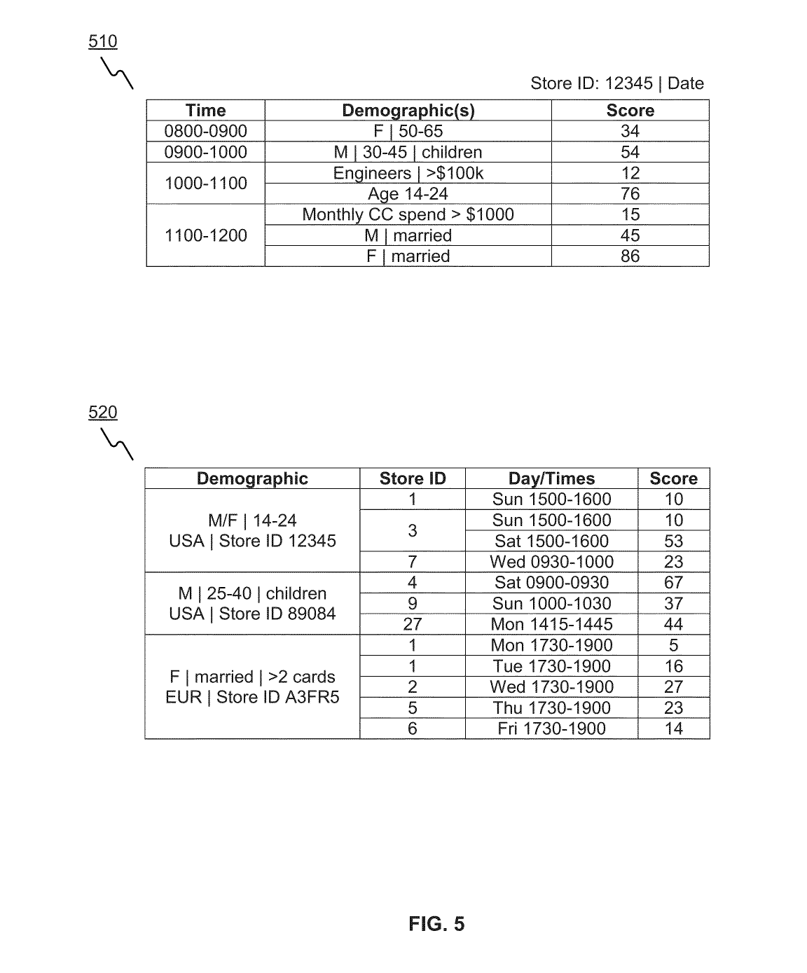

FIG. 5 is a block diagram of exemplary aggregate consumer data that may be compiled about consumers in stores, consistent with disclosed embodiments. In some embodiments, a back-end server may aggregate graphs, such as FIG. 4 (401-403), for a plurality of users. Using such aggregated data, the back-end server may compile statistical data regarding the user demographics of consumers with particular merchants, the times during which such demographics frequent the merchant's electronic/physical stores (see 404), and the like. The back-end server may also calculate a relative interest level (or score) between user demographics in a particular merchant, store, or retail channel (electronic, television, phone, brick-and-mortar), based in part on the frequency with which members of each user demographic visit the merchant via each retail channel, and an amount of consumption behavior that members of each user demographic exhibits. The back-end server may present such statistical data in a number of ways. As an illustration, the back-end server may present the data in a table 510 dividing the statistical data according to time slots within the day, and may present the user demographics that visited a particular display, and a score associated with that user demographic for that display, for that particular day and time slot. As another illustration, the back-end server may present the data in a table 520 dividing the statistical data according to user demographics, and may present the time slots within the day that each user demographic most visited the merchant, and a score associated with that user demographic for that merchant, for that particular day and time slot. In general, it is to be understood that any manner of statistical analysis of individual or aggregate customer information, either separately from or tied to user profile or user demographic information, is contemplated by this disclosure.

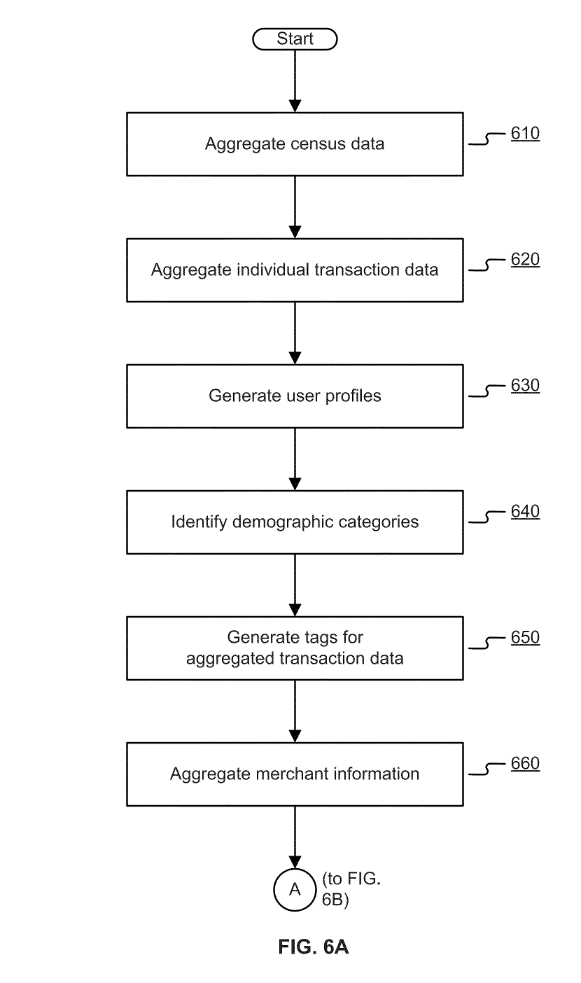

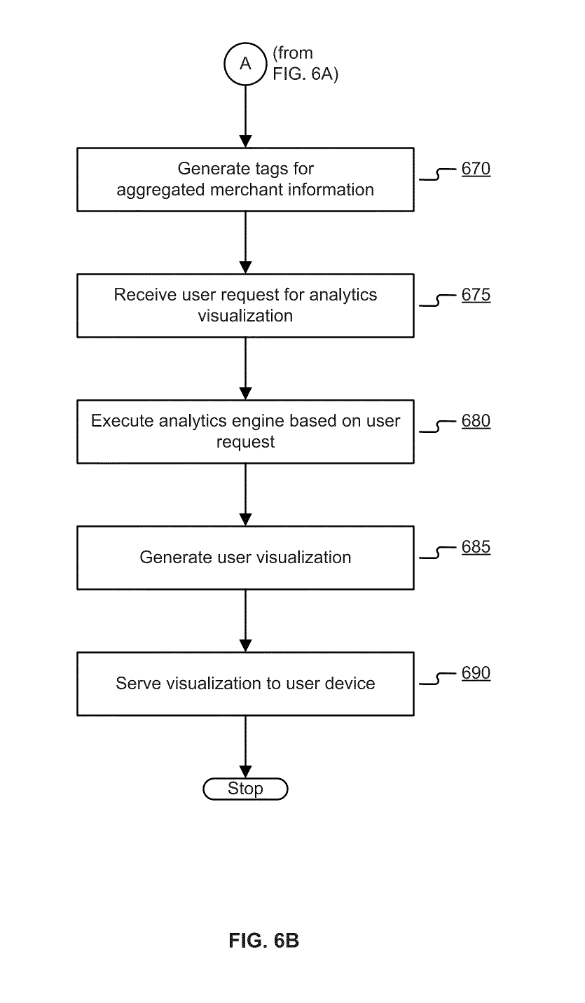

FIGS. 6A-B is a flowchart of an exemplary process for implementing merchant business intelligence tools, consistent with disclosed embodiments. With reference to FIG. 6A, at step 610, system 100 may aggregate census data. System 100 may receive such data from various sources, e.g., web crawlers, online surveys, and the like. At step 620, system 100 may also aggregate individual transaction data, such as purchase product information, payment type, payment information, user financial profile information such as billing and shipping address, etc., relating to purchases made by consumers from merchants. Using the aggregated census data and individual transaction data, at step 630, system 100 may generate user profiles. The system 100 may receive additional data from various sources, e.g., web crawlers, social networks, applications executing on user devices, etc., to generate the user profiles. The user profiles may include information such as, without limitation, age, gender, marital status, family size, financial account information, credit card or banking information, occupation, salary, and/or the like. System 100, at step 640, may analyze the aggregated user profiles, and may embed tags into the user profile records. These tags may represent various demographic categories to which the user may belong based on, e.g., age, gender, marital status, income level, consumption amount, frequency of consumption, type of consumptions, occupation, etc. In some embodiments, at a step 650, system 100 may generate tags for aggregated transaction data. The tags may, for example, indicate a type of product, type of payment used for the transaction (e.g., virtual wallet, debit, credit, etc.), a geographic location, a merchant identifier, a retail channel identifier, and/or the like. Also, system 100, at step 660, may aggregate merchant information, e.g., identification, trademark names, addresses, retail channels (e.g., phone, TV, online, brick-and-mortar, etc.), inventory, advertisements, etc. Inventory information may include fields such as, without limitation, store ID, stock-keeping unit (SKU) ID, SKU name, quantity, stock date, expiry date, retail price, and/or the like.

With reference to FIG. 6B, at step 670, system 100 may analyze aggregated merchant information, and may embed tags into the merchant information records. These tags may, for example, indicate a merchant type (small, large, sole proprietorship, etc.), merchant available retail channels, merchant geographic locations, and/or the like. At step 675, system 100 may receive a user request for a visualization of analytics regarding any of the aggregated data obtained by system 100. For example, a merchant user, operating a user device 110, may provide a request to back-end server 140 to provide a visualization of analytics extracted from aggregated data stored in database 130. At step 680, system 100 may operate on the tagged records, as well as the raw underlying aggregated information, to execute an analytics engine to identify trends, recognize data patterns, and draw inferences from the tags and aggregated data. The analytics engine 380 may provide such intelligence information to a visualization engine, which, at step 685, may render the information in a form ready for presentation via a display device (e.g., user device 110) to a user. At step 690, system 100 may provide the visualization to the user device for display.

FIGS. 7-9 depict exemplary user interfaces for a merchant business intelligence tool. With reference to FIG. 7, in some embodiments, a user device 110 may execute a browser application 700 capable of presenting various types of interactive content for a user. For example, the browser application 700 may provide a webpage 705 depicting analytics information for a merchant on customers of the merchant. In one aspect, the merchant may be selected by providing search terms into a user interface element 710, such as a text input field. Additionally, a user may filter the aggregated data according to various parameters depicted in FIG. 7, 715-765. For example, the user may select certain geographic locations (see 720), certain customer types (see 725), certain genders (see 730), certain ages (see 735), certain frequencies of visits to retail stores of the merchant (see 740), certain time periods (see 750), certain times of day (see 755), certain days of the week (see 760), and/or certain retail channels (see 765).

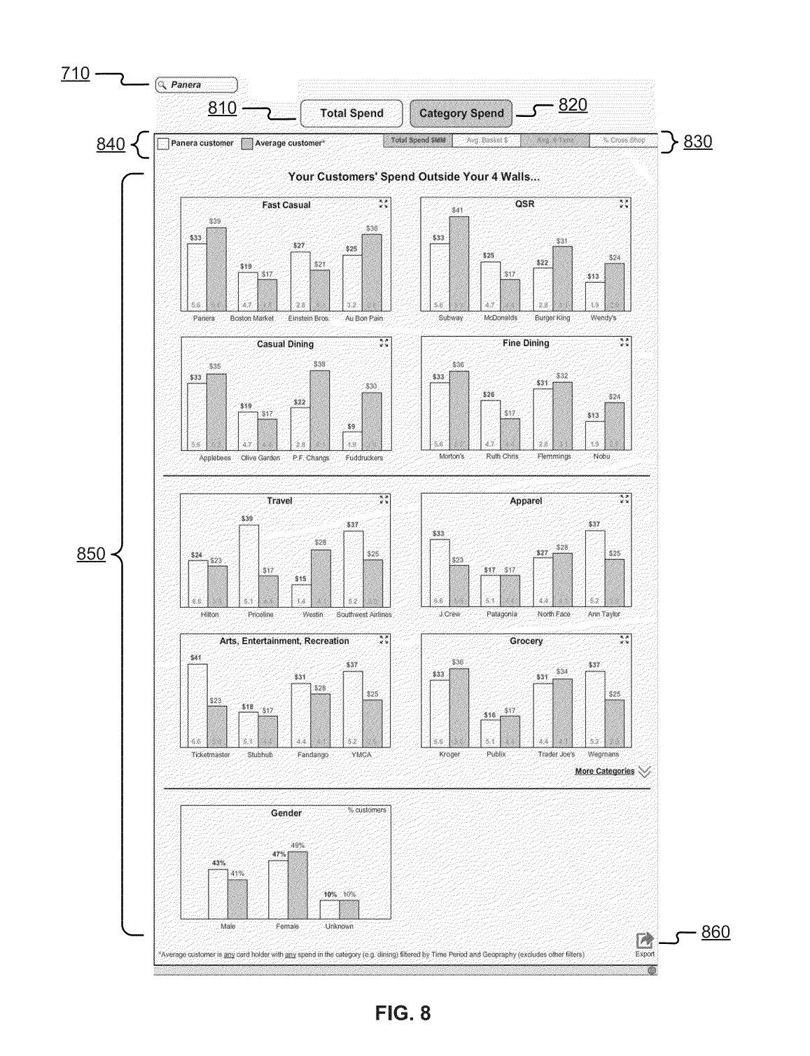

With reference to FIG. 8, in some embodiments, upon selecting criteria for filtering the aggregated data, the browser application 700 may provide a user interface screen including analytics on the filtered aggregated data. A user may be able to select different views of the data (e.g., total spend 810, category spend 820); visualization 850 may automatically be refreshed according to such selections. The visualization 850 may, in some embodiments, compare behavior of customers of the merchant against an average customer behavior across all aggregated data (see 840), so that the merchant may understand the merchant's performance relative to an average benchmark. In addition, a user may select from additional options (see 830), to visualize other parameters, such as total customer expenditure, average value of a basket of goods purchased during a single visit, an average number of transactions, and an amount of cross-shopping with other merchants.

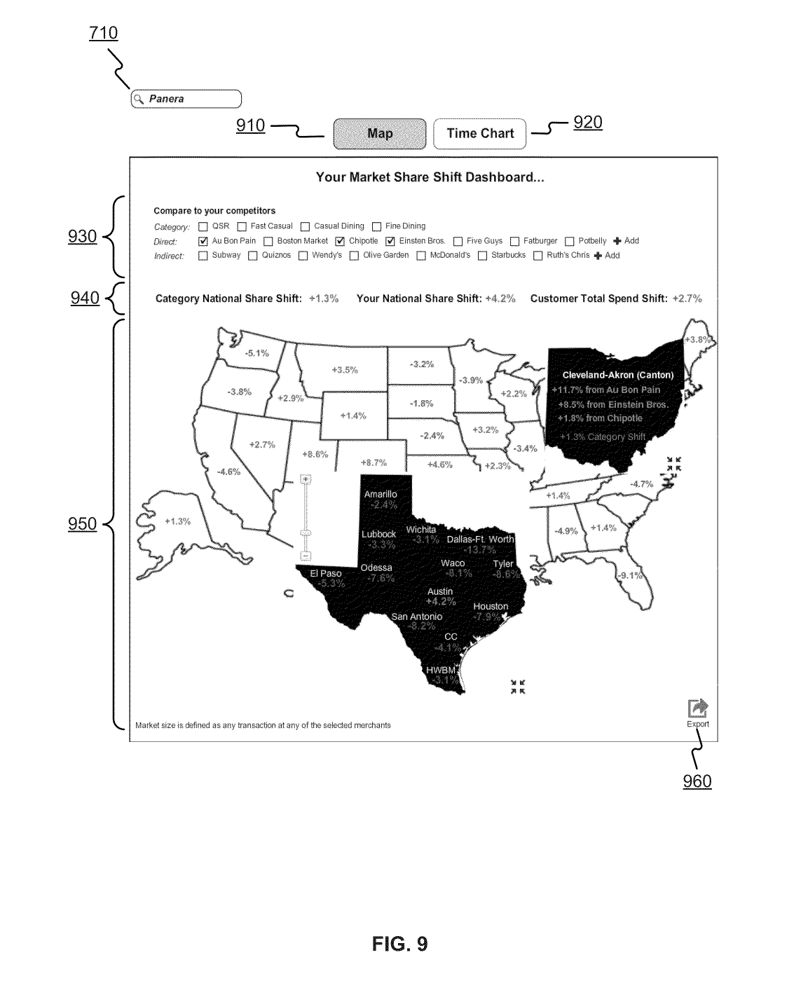

With reference to FIG. 9, in some embodiments, the browser application 700 may provide another user interface screen including analytics data resolved by geographical locations of the merchant. For example, a user can select a map view (see 910), and obtain a visualization 950 of data resolved by geographical locations. A user may select other merchants against which analytical comparisons should be made (see 930), and browser application 700 may provide displays of information (e.g., as percentages relative to other merchants) resolved by geographical location. Also, browser application 700 may display information that aggregates results across all relevant geographical locations (see 940), so that the user can obtain analytic data pertaining to an average across all geographical locations included in the filter selections (see FIG. 7, 720). In some embodiments, a user may select a time chart view (see 920), and obtain a similar analysis resolved by time rather than by geographical location. In each user interface screen, a user interface element (e.g., 860, 960) may be provided to export the visualization (e.g., 850, 950) itself, and/or data underlying the visualization, to another file format.

In some examples, some or all of the logic for the above-described techniques may be implemented as a computer program or application or as a plug-in module or subcomponent of another application. The described techniques may be varied and are not limited to the examples or descriptions provided.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments. For example, while a merchant has been referred to herein for ease of discussion, it is to be understood that consistent with disclosed embodiments another entity may provide such services in conjunction with or separate from a merchant or other service provider.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

1. A merchant business intelligence system, comprising:
one or more memory devices storing instructions; and
one or more hardware processors configured to execute the instructions to perform operations comprising:
aggregating data relating to one or more merchants, one or more customers, and transactions involving the one or more customers or the one or more merchants;
identifying one or more categories for the one or more customers, the one or more merchants, and the transactions;
filtering the aggregated data according to a subset of the categories of the one or more customers, the one or more merchants, or the transactions;
generating an analytic visualization based on an analysis of the filtered aggregated data; and
providing the generated analytic visualization for display.

2. The system of claim 1, the operations further comprising:
aggregating the data using at least one of: a web crawler; an online survey; or a social networking system.

3. The system of claim 1, the operations further comprising:
obtaining a user input; and filtering the aggregated data according to the user input.

4. The system of claim 1, the operations further comprising:
providing the generated analytic visualization in a format capable of being rendered by a web browser.

5. The system of claim 1, the operations further comprising:
obtaining a user input for customizing the analytic visualization;
generating an updated analytic visualization in response to the user input for customizing the analytic visualization; and
providing the updated analytic visualization for display in real-time.

6. A method for providing merchant business intelligence, comprising:
aggregating data relating to one or more merchants, one or more customers, and transactions involving the one or more customers or the one or more
merchants;
identifying one or more categories for the one or more customers, the one or more merchants, and the transactions;
filtering the aggregated data according to a subset of the categories of the one or more customers, the one or more merchants, or the transactions;
generating an analytic visualization based on an analysis of the filtered aggregated data; and
providing the generated analytic visualization for display.

7. A non-transitory computer readable medium storing instructions that, when executed by one or more hardware processors, configures the one or more hardware processors to perform operations comprising:
aggregating data relating to one or more merchants, one or more customers, and transactions involving the one or more customers or the one or more merchants;
identifying one or more categories for the one or more customers, the one or more merchants, and the transactions;
filtering the aggregated data according to a subset of the categories of the one or more customers, the one or more merchants, or the transactions;
generating an analytic visualization based on an analysis of the filtered aggregated data; and providing the generated analytic visualization for display.

8. The method of claim 6, further comprising:
aggregating the data using at least one of: a web crawler, an online survey, or a social networking system.

9. The method of claim 6, further comprising:
obtaining a user input; and filtering the aggregated data according to the user input.

10. The method of claim 6, further comprising:
providing the generated analytic visualization in a format capable of being rendered by a web browser.

11. The method of claim 6, further comprising:
obtaining a user input for customizing the analytic visualization;
generating an updated analytic visualization in response to the user input for customizing the analytic visualization; and
providing the updated analytic visualization for display in real-time.

12. The non-transitory computer readable medium of claim 7, the operations further comprising:
aggregating the data using at least one of: a web crawler, an online survey, or a social networking system.

13. The non-transitory computer readable medium of claim 7, the operations further comprising:
obtaining a user input; and
filtering the aggregated data according to the user input.

14. The non-transitory computer readable medium of claim 7, the operations further comprising:
providing the generated analytic visualization in a format capable of being rendered by a web browser.

15. The non-transitory computer readable medium of claim 7, the operations further comprising:
obtaining a user input for customizing the analytic visualization;
generating an updated analytic visualization in response to the user input for customizing the analytic visualization; and
providing the updated analytic visualization for display in real-time.

16. The system of claim 1, the operations further comprising:
comparing the filtered aggregated data with the aggregated data; and
wherein the generated visualization includes a depiction of the comparison.

17. The system of claim 3, wherein the user input comprises one or more search terms.

18. The method of claim 6, further comprising:
comparing the filtered aggregated data with the aggregated data; and
wherein the generated visualization includes a depiction of the comparison.

19. The system of claim 9, wherein the user input comprises one or more search terms.

20. The non-transitory computer readable medium of claim 7, the operations further comprising:
comparing the filtered aggregated data with the aggregated data; and
wherein the generated visualization includes a depiction of the comparison.
